(19) United States
(12) Patent Application Publication
(10) Pub. No.: US 2025/0188286 A1
(43) Pub. Date: Jun. 12, 2025

(54) METHODS FOR TREATING SUBSTRATES

(71) Applicant: Capsulated Systems, Inc., Ithaca, NY (US)

(72) Inventors: Roland M. LYNCH, Bethlehem, PA (US); Morris N. NEWSOM, JR., Xenia, OH (US)

(21) Appl. No.: 19/061,745

(22) Filed: Feb. 24, 2025

Related U.S. Application Data
(62) Division of application No. 17/751,377, filed on May 23, 2022.

(51) Int. Cl. C09D 5/08; C08G 18/62; C08G 18/75; C09D 123/08; C09D 131/04; C09D 175/04

(52) U.S. Cl. CPC C09D 5/08; C08G 18/6212; C08G 18/758; C09D 123/0853; C09D 131/04; C09D 175/04

(57) ABSTRACT

The disclosure relates to compositions and methods useful for treating a substrate, for example for preventing or inhibiting corrosion of metal substrates. The compositions comprise (a) at least one cross-linkable, partially hydrolyzed polymer, and (b) at least one particular crosslinking agent.

### TECHNICAL FIELD

The disclosure relates to compositions for treating substrates, and methods of treating the substrates with the compositions. The compositions and methods may be particularly useful for preventing and/or reducing corrosion of metal substrates, and may have reduced or no yellowing over time.

### BACKGROUND

For more than 80 years, high-performance organic coatings have been the pinnacle of global corrosion control and corrosion management. Yet despite their evolving sophistication and reformulations, these coatings have failed to adequately address the global problem of corrosion. Consequently, the cost of managing corrosion today is approximately 3.1% of global GDP.

Excluded from this cost is the expense of restoring the world's oil and gas infrastructure, and current global infrastructure requirements in the trillions of dollars. These dilemmas make the need to solve the problem of corrosion both apparent and immediate.

Anticorrosive and protective coatings are typically applied as primers because they function by the inter-reaction of constituents or pigments in the coating with the metal substrate. In order to improve the corrosion resistance of the metal substrate, corrosion inhibitive sacrificial components or additives are typically used. These coatings are generally classified in accordance with the mechanisms by which they protect metal against corrosion: barrier coatings, inhibitive coatings, and sacrificial coatings. Barrier Coatings are coatings that act by blocking the transport or transmission of aggressive species into the coating's surface, such as water or gases (e.g. CO₂ or SO₂) in industrial atmosphere, chloride ions, or ultraviolet (UV) radiation that can penetrate a cured coating. Barrier coatings are simply relatively thick coatings (usually approximately 10-40 mils) composed of relatively moisture-resistant resins. Inhibitive coatings in contrast, attempt to avoid corrosion by reacting with the environment to provide a protective film or barrier on the metallic surface. They are typically comprised of pigments that react with the steel substrate to produce thin films that serve to passivate the metal surface. Lead-based paints are one example of these inhibitive coatings. Sacrificial coatings are coatings that rely on the principle of galvanic corrosion for the protection of metals against corrosion. The substrate is typically coated with primers containing high levels (e.g. 70-90 wt %) of metallic zinc dust pigments that form a coat-of-metal over the substrate which corrodes preferentially to steel. Additionally, since zinc is active electrochemically, it corrodes more slowly than steel allowing longer periods between coatings. This includes cathodic protective coatings.

These basic and fundamental approaches are currently the only solutions the industry has for preventing, stopping, and/or managing corrosion, despite their poor history of protection success. However, to date such protective coatings have not been sufficiently satisfactory, in particular in that they typically require application of multiple compositions, yellow over time, are not sufficiently impermeable to the elements that cause corrosion, and/or do not offer adequate adhesion to the substrate to allow the coating to be long-lasting.

Weathering and aging of paint are among many factors that contribute, in various degrees, to degradation of such coatings. Typical weathering stress factors include UV radiation, water and moisture uptake, elevated temperatures, and chemical damage from pollutants. Of course, interactions between these stresses are to be expected. For example, as the polymeric backbone of a coating is slowly broken down by UV light, the coating's barrier properties likewise typically deteriorate.

One particular challenge is UV breakdown of constituents of known coatings. Sunlight is a major source of UV radiation on many coated metal substrates. Although its affects are usually associated with aesthetic changes such as yellowing, color change or loss, chalking, gloss reduction, and lowered distinctness of images, there are other important UV-related changes as well, such as chemical breakdown and worsened mechanical properties. Such changes can lead to, for example, embrittlement, increased hardness, increased internal stress, hydrophilicity, altered solubility, and crosslink density, and generation of polar groups at the surface, which may lead to increased surface wettability.

Epoxies, because of their strength, chemical resistance, and adhesion to substrates, are an important class of anticorrosive paint. However, because of their susceptibility (most impervious) to UV degradation, they are primarily used as primers and rely upon intermediate and/or top-coatings that contain UV-resistant binders, to complete each epoxy coating task or epoxy coating system.

Furthermore, the inclusion of various pigments in anticorrosion coating compositions can interfere with the physical and/or mechanical properties of the coating compositions.

Thus, there is a need for compositions that provide highly corrosion-resistant coatings, have good adhesion to metal substrates, have good barrier or impermeability properties, have good corrosion and/or weathering resistance, have good UV resistance (e.g. do not, or do not significantly, yellow over time with UV exposure), and/or can incorporate various pigments. Ideally, the composition(s) can provide such benefits in a one-coat process, or can be a system including a primer, together with one or more of an intermediate coat, top coat, and/or sealer.

### SUMMARY

Compositions that are useful for treating substrates, in particular for reducing and/or preventing corrosion of metal substrates, methods of making the compositions, films prepared from the compositions, and methods of using the films and compositions are described herein. The films and compositions have a surprising benefit in that they do not, or do not substantially, yellow over time.

In one embodiment, the disclosure relates to compositions for preventing and/or reducing corrosion of a substrate, e.g. a metal substrate, comprising (a) at least one cross-linkable, partially hydrolyzed polymer; and (b) at least one crosslinking agent chosen from aliphatic and/or cycloaliphatic diisocyanates having (i) a molecular weight ranging from about 150 g/mol to about 600 g/mol, (ii) an N═C═O content ranging from about 20% to about 45%, (iii) a viscosity of greater than or equal to about 15 mPa-s, and/or (iv) from about 5% to about 35% of the trans-, trans-stereoisomer, from about 10% to about 50% of the cis-, cis-stereoisomer, and from about 35% to about 65% of the cis-, trans-stereoisomer.

The compositions may have a weight ratio of cross-linkable, partially hydrolyzed polymer to crosslinking agent ranging from about 6:1 to about 1:6, and/or a degree of crosslinking ranging from about 25% to about 50%. In some embodiments, the at least one cross-linkable, partially hydrolyzed polymer has a molecular weight ranging from about 10,000 to about 250,000. In some embodiments, the at least one cross-linkable, partially hydrolyzed polymer comprises vinyl ester-based monomer units and ethylene monomer units. Optionally, the vinyl ester-based monomer units comprise vinyl acetate monomer units, and in some embodiments the vinyl ester content of the cross-linkable, partially hydrolyzed polymer ranges from about 1 mol % to about 55 mol %. In some embodiments, the cross-linkable, partially hydrolyzed polymer has a degree of hydrolysis ranging from about 10% to about 80% or from about 25% to about 75%.

In one embodiment, the disclosure relates to compositions for preventing and/or reducing corrosion of a substrate, e.g. a metal substrate, comprising (a) at least one cross-linkable, partially hydrolyzed polymer; and (b) at least one crosslinking agent chosen from aliphatic and/or cycloaliphatic diisocyanates having (i) a molecular weight ranging from about 240 g/mol to about 285 g/mol, (ii) an N═C═O content ranging from about 30% to about 35%, (iii) a viscosity ranging from about 25 mPa-s to about 35 mPa·s, and (iv) from about 15% to about 25% of the trans-, trans-stereoisomer, from about 25% to about 35% of the cis-, cis-stereoisomer, and from about 45% to about 55% of the cis-, trans-stereoisomer.

In at least some embodiments, the crosslinking agent includes 4,4′-methylenedi(cyclohexyl isocyanate).

In various embodiments, the disclosure relates to compositions for preventing and/or reducing corrosion of a substrate, e.g. a metal substrate, comprising (a) at least one cross-linkable, partially hydrolyzed polymer comprising vinyl ester-based monomer units and ethylene monomer units; and (b) at least one crosslinking agent chosen from cycloaliphatic diisocyanates having (i) a molecular weight ranging from about 150 g/mol to about 600 g/mol, (ii) an N═C═O content ranging from about 20% to about 45%, and (iii) a viscosity of greater than or equal to about 15 mPa·s. Optionally, the cross-linkable, partially hydrolyzed polymer is poly(ethylene vinyl acetate) having an ethylene content ranging from about 60% to about 80%, a vinyl alcohol content ranging from about 7% to about 18%, and a vinyl acetate content ranging from about 10% to about 25%, and/or the crosslinking agent comprises 4,4′-methylenedi(cyclohexyl isocyanate). Further, the weight ratio of cross-linkable, partially hydrolyzed polymer to crosslinking agent may range from about 6:1 to about 1:6, and/or the cross-linkable, partially hydrolyzed polymer may have a degree of crosslinking ranging from about 20% to about 75%, such as from about 25% to about 50%.

In various embodiments, the disclosure relates to substrates, e.g. metal substrates, comprising the compositions according to the disclosure, and/or methods of reducing and/or preventing corrosion of substrates that comprise applying compositions according to the disclosure to the substrates.

In one embodiment, the disclosure relates to methods for treating a substrate, comprising applying to the substrate a composition prepared by crosslinking (a) a cross-linkable, partially hydrolyzed polymer comprising poly(ethylene vinyl acetate) having an ethylene content ranging from about 60% to about 80%, a vinyl alcohol content ranging from about 7% to about 18%, and a vinyl acetate content ranging from about 10% to about 25%, and (b) a crosslinking agent comprising 4,4′-methylenedi(cyclohexyl isocyanate), wherein the cross-linkable, partially hydrolyzed polymer has a molecular weight ranging from about 25,000 to about 200,000, a degree of hydrolysis ranging from about 30% to about 60%, and a degree of crosslinking ranging from about 25% to about 50%, and wherein the crosslinking reaction occurs at a temperature ranging from about 20° C. to about 30° C., such as from about 21° C. to about 27° C., or from about 22° C. to about 26° C. The method may, for example, be a method for treating a corrodible substrate to prevent or inhibit corrosion thereof.

In some embodiments, the disclosure relates to methods for reducing and/or eliminating yellowing of a substrate, comprising applying to the substrate a composition prepared by crosslinking (a) a cross-linkable, partially hydrolyzed polymer comprising poly(ethylene vinyl acetate) having an ethylene content ranging from about 60% to about 80%, a vinyl alcohol content ranging from about 7% to about 18%, and a vinyl acetate content ranging from about 10% to about 25%, and (b) a crosslinking agent comprising 4,4′-methylenedi(cyclohexyl isocyanate), wherein the cross-linkable, partially hydrolyzed polymer has a molecular weight ranging from about 25,000 to about 200,000, a degree of hydrolysis ranging from about 30% to about 60%, and a degree of crosslinking ranging from about 25% to about 50%, and wherein the crosslinking reaction occurs at a temperature ranging from about 20° C. to about 30° C., such as from about 21° C. to about 27° C., or from about 22° C. to about 26° C.

In other embodiments, the disclosure relates to a cross-linked, thermoset polymer. The backbone of the system may comprise, consist essentially of, or consist of poly(ethylene-co-vinyl acetate) that is partially hydrolyzed, which hydrolysis may unblock or liberalize hydroxyl “functional” groups that can undergo crosslinking with a diisocyanate monomer, e.g. 4,4′-methylenedi(cyclohexyl isocyanate), during a coating or macro encapsulation process at a surface of a substrate. The disclosure also relates to compositions and films comprising the cross-linked, thermoset polymer.

### BRIEF DESCRIPTION OF THE FIGURES

The accompanying drawings, which are incorporated herein and constitute part of this specification, illustrate exemplary embodiments of the disclosure, and, together with the general description given above and the description provided herein, serve to explain features of the disclosure.

FIG. 1 is a graph comparing impermeability levels imparted by compositions according to the disclosure compared to known anti-corrosion coatings.

FIG. 2 is a graph comparing adhesion levels of compositions according to the disclosure compared to known anti-corrosion coatings.

FIGS. 3A-3B show an illustration of how compositions according to the disclosure adhere to a substrate (3A), and how known anti-corrosion coatings adhere to the same substrate (3B).

### DETAILED DESCRIPTION

The disclosure relates to compositions that are useful for treating substrates, which can be used for example for reducing and/or preventing corrosion, and which are prepared by crosslinking a cross-linkable, partially hydrolyzed polymer with a particular cross-linking agent. When these components are mixed, they form a cross-linked polymer that forms on the surface of a variety of substrates, providing a coating or film which has surprisingly significantly improved adhesion and impermeability properties while having the benefit of not, or not substantially, yellowing over time, compared to currently available anti-corrosion coatings.

### Cross-Linkable Polymer

According to various embodiments, the cross-linkable polymer is a hydrolysable film-forming polymer. In certain embodiments, the cross-linkable polymer has a molecular weight of less than 500,000, such as, for example, less than 250,000, for example ranging from about 10,000 to about 250,000, or from about 25,000 to about 200,000.

In certain embodiments, the cross-linkable polymer comprises vinyl ester-based monomer units. For example, the monomers may be chosen from vinyl esters of α-monosubstituted fatty acids, vinyl esters of neoalkanoic acids and α-olefins, or mixtures thereof. In certain embodiments, the monomers are chosen from vinyl esters of saturated, branched monocarboxylic acids having from 1 to 20, such as from 1 to 18 or from 1 to 16, carbon atoms in the acid radical, vinyl esters of relatively long-chain, saturated or unsaturated fatty acids, vinyl esters of benzoic acid and substituted derivatives of benzoic acid, or mixtures thereof. For example, the vinyl ester-based monomers may be chosen from vinyl acetate, vinyl formate, vinyl hexanoate, vinyl benzoate, vinyl propionate, vinyl butyrate, vinyl isobutyrate, vinyl pivalate, vinyl 2-ethylhexanoate, vinyl valerate, vinyl isooctanoate, vinyl nonoate, vinyl decanoate, vinyl pivalate, vinyl versatate, vinyl laurate, vinyl stearate, vinyl p-tert-butylbenzoate, or mixtures thereof. In a particular embodiment, the cross-linkable polymer includes vinyl acetate monomer units.

The vinyl ester content of the cross-linkable polymer can range up to about 60 mol %, for example from about 1 mol % to about 55 mol %, from about 2 mol % to about 50 mol %, from about 3 mol % to about 45 mol %, from about 4 mol % to about 40 mol %, or from about 5 mol % to about 35 mol %. In some embodiments, the vinyl ester content of the cross-linkable polymer ranges from about 10 mol % to about 30 mol %, or from about 15 mol % to about 25 mol %.

In various embodiments, the cross-linkable polymer further includes at least one monomer other than vinyl ester-based monomers, where the additional monomer(s) are chosen from styrene, methyl methacrylate, acrylic acid, and/or ethylene. In a particular embodiment, the cross-linkable polymer includes ethylene monomer units.

In various embodiments, the content of monomers other than vinyl ester-based monomers in the cross-linkable polymer ranges from about 40 mol % to about 92 mol %, such as from about 50 mol % to about 90 mol % or from about 60 mol % to about 88 mol %.

Methods for making the polymers using the monomers described herein are well known in the art. For example, typical methods such as introducing the monomers, e.g. ethylene and vinyl acetate, into a high-pressure polymerizing vessel with a jacket, coil, and/or a reflux condenser, together with an alcoholic solvent such as methanol, can be used.

In some embodiments, the cross-linkable polymer comprises, consists essentially of, or consists of a hydrolyzable, cross-linkable ethylene vinyl acetate copolymer.

Thus, in at least some embodiments, the partially hydrolyzed cross-linkable polymer comprises ethylene monomers, vinyl acetate monomers, and vinyl alcohol monomers, and is represented by general formula (I):

—(CH₂CHOH)ₓ—(CH₂CH₂)_{y}—(CH₂CHOCOCH₃)_{z}— (I)

wherein x, y, and z represent mol fractions of ethylene, vinyl alcohol, and vinyl acetate, respectively, where the polymer has a degree of hydrolysis as described above. In at least some embodiments, the mole ratio of the vinyl alcohol groups to the sum of vinyl alcohol groups and the vinyl acetate groups can range from about 0.1 to about 1, such as about 0.125 to about 0.85, or about 0.15 to about 0.7.

In one exemplary and non-limiting embodiment, the cross-linkable polymer for use according to the disclosure is poly(ethylene vinyl acetate), which may contain from about 60 mol % to about 88 mol % ethylene and having from about 38% to about 55%, about 40% to about 50%, or about 44% to about 46% of the vinyl acetate groups hydrolyzed to vinyl alcohol groups to provide reaction sites for cross-linking.

Other suitable cross-linkable polymers include poly(vinyl formal) polymers, poly(vinyl butyral) polymers, alkylated cellulose (e.g., ethyl cellulose), acylated cellulose (e.g., cellulose acetate butyrate), and the like. Combinations of cross-linkable polymers may also be chosen.

In at least certain embodiments, the cross-linkable polymers have a melt index (using a 2160 gram force at 190° C., for 10 minutes) of from about 5 to about 70 or from about 15 to about 60, preferably from about 25 to about 50 or from about 35 to about 45.

In one embodiment, the cross-linkable polymer is chosen from poly(ethylene vinyl acetate) having a melt index ranging from about 30 to about 40, such as from about 35 to about 37, and having about 40% to about 50%, such as from about 44% to about 46% of the vinyl acetate groups hydrolyzed to vinyl alcohol groups. This polymer preferably has an ethylene content ranging from about 60% to about 80%, such as from about 65% to about 75% or about 67% to about 72%, for example about 70%, a vinyl alcohol content ranging from about 7% to about 18%, such as from about 10% to about 14%, for example from about 12% to about 13%, and a vinyl acetate content ranging from about 10% to about 25%, such as from about 16% to about 20%, for example from about 17% to about 18%.

Methods for partially hydrolyzing polymers are also known. One particularly useful method is described in U.S. Pat. No. 4,377,621, the disclosure of which is incorporated herein by reference in its entirety. This method provides a cross-linkable polymer with a degree of hydrolysis ranging from about 10% to about 90%, for example from about 15% to about 80%, from about 20% to about 70%, from about 25% to about 65%, from about 30% to about 60%, or from about 35% to about 55%, any of which ranges are suitable according to the disclosure. For example, the partially hydrolyzed cross-linkable polymer may, in various embodiments, have a degree of hydrolysis ranging from about 38% to about 55%, from about 40% to about 50%, or from about 44% to about 46%. In other embodiments, the partially hydrolyzed cross-linkable polymer may have a degree of hydrolysis ranging from about 25% to about 75%.

### Crosslinking Agent

It has been surprisingly and unexpectedly discovered that by crosslinking the cross-linkable, partially hydrolyzed polymer with a particular cross-linking agent, compositions according to the disclosure demonstrate superior adhesion to metal substrates as well as superior corrosion and/or weathering resistance compared to known anti-corrosion coatings, and further do not yellow over time and/or under UV light exposures, and allow the incorporation of various components such as pigments therein, thus permitting the compositions and methods to provide a one-step process for treating a substrate, e.g. for reducing or preventing corrosion of the substrate.

In particular, aliphatic and/or cycloaliphatic diisocyanates having certain particular properties are used. Preferably, cycloaliphatic diisocyanates having such properties are chosen. Thus, in various embodiments, the compositions are free or substantially free of aromatic isocyanates, such as aromatic diisocyanates and/or aromatic polyisocyanates.

In various embodiments, aliphatic and/or cycloaliphatic diisocyanates having a molecular weight less than about 750 g/mol, such as less than about 600 g/mol, or less than about 300 g/mol, can be used. In other embodiments, aliphatic and/or cycloaliphatic diisocyanates having a molecular weight greater than about 150 g/mol, such as greater than about 200 g/mol, or greater than about 250 g/mol, can be used. In further embodiments, aliphatic and/or cycloaliphatic diisocyanates having a molecular weight ranging from about 150 g/mol to about 600 g/mol, such as from about 175 g/mol to about 350 g/mol, from about 200 g/mol to about 325 g/mol, from about 225 g/mol to about 300 g/mol, from about 240 g/mol to about 275 g/mol, or from about 250 g/mol to about 270 g/mol, may be used. In still further embodiments, aliphatic and/or cycloaliphatic diisocyanates having a molecular weight ranging from about 250 g/mol to about 600 g/mol, such as from about 350 g/mol to about 550 g/mol, from about 450 g/mol to about 525 g/mol, or about 500 g/mol, may be used. In some particular embodiments, aliphatic and/or cycloaliphatic diisocyanates having a molecular weight ranging from about 260 g/mol to about 265 g/mol, such as about 262 g/mol, may be chosen.

In certain embodiments, aliphatic and/or cycloaliphatic diisocyanates having an N═C═O content of less than about 45% can be chosen, for example ranging from about 20% to about 45%. In other embodiments, aliphatic and/or cycloaliphatic diisocyanates having an N═C═O content of less than about 40% can be chosen, for example ranging from about 20% to about 40%. In still further embodiments, aliphatic and/or cycloaliphatic diisocyanates having an N═C═O content of less than about 37% can be chosen, for example ranging from about 20% to about 37%, from about 25% to about 35%, from about 30% to about 34%, or from about 31% to about 32%. In further embodiments still, aliphatic and/or cycloaliphatic diisocyanates having an N═C═O content of less than about 25% can be chosen, for example ranging from about 15% to about 25%, from about 20% to about 25%, from about 21% to about 24%, or from about 22% to about 23%. In some particular embodiments, aliphatic and/or cycloaliphatic diisocyanates having an N═C═O content of greater than or equal to about 31%, or greater than or equal to about 32%, can be chosen.

In certain embodiments, aliphatic and/or cycloaliphatic diisocyanates having a viscosity of greater than or equal to about 10 mPa·s or greater than or equal to about 15 mPa·s, such as, for example, ranging from about 20 mPa-s to about 40 mPa·s, from about 22 mPa·s to about 38 mPa·s, from about 25 mPa·s to about 35 mPa·s, from about 27 mPa·s to about 33 mPa·s, or from about 29 mPa·s to about 31 mPa·s, for example about 30 mPa-s, are chosen. As a further embodiment, aliphatic and/or cycloaliphatic diisocyanates having a viscosity ranging from about 10 mPa·s to about 40 mPa-s, from about 15 mPa·s to about 38 mPa·s, from about 20 mPa·s to about 35 mPa-s, from about 25 mPa·s to about 33 mPa·s, or from about 27 mPa·s to about 32 mPa-s, may be chosen.

In certain embodiments, aliphatic and/or cycloaliphatic diisocyanates having a mixture of cis- and trans-isomers is used. For example, the aliphatic and/or cycloaliphatic diisocyanates preferably have some proportion of the trans-, trans-stereoisomer, some proportion of the cis-, cis-stereoisomer, and/or some proportion of the cis-, trans-stereoisomer. Preferably, the aliphatic and/or cycloaliphatic diisocyanates have some proportion of the trans-, trans-stereoisomer, some proportion of the cis-, cis-stereoisomer, and some proportion of the cis-, trans-stereoisomer. By way of example, in some embodiments, aliphatic and/or cycloaliphatic diisocyanates having from about 5% to about 35%, for example about 10% to about 30%, about 15% to about 25%, particularly about 18% to about 22% or about 20%, of the trans-, trans-stereoisomer may be used. In other embodiments, aliphatic and/or cycloaliphatic diisocyanates having from about 10% to about 50%, for example about 15% to about 45%, about 20% to about 40%, particularly about 25% to about 35%, about 28% to about 32%, or about 30%, of the cis-, cis-stereoisomer are used. In still further embodiments, aliphatic and/or cycloaliphatic diisocyanates having from about 35% to about 65%, for example about 40% to about 60%, about 45% to about 55%, particularly about 48% to about 52% or about 50%, of the cis-, trans-stereoisomer are used. In further embodiments still, aliphatic and/or cycloaliphatic diisocyanates having from about 5% to about 35%, such as about 10% to about 30%, about 15% to about 25%, particularly about 18% to about 22% or about 20%, of the trans-, trans-stereoisomer, from about 10% to about 50%, such as about 15% to about 45%, about 20% to about 40%, particularly about 25% to about 35%, about 28% to about 32%, or about 30%, of the cis-, cis-stereoisomer, and from about 35% to about 65%, such as about 40% to about 60%, about 45% to about 55%, particularly about 48% to about 52% or about 50%, of the cis-, trans-stereoisomer are chosen. In one preferred embodiment, aliphatic and/or cycloaliphatic diisocyanates having from about 18% to about 22% of the trans-, trans-stereoisomer, from about 28% to about 32% of the cis-, cis-stereoisomer, and from about 48% to about 52% of the cis-, trans-stereoisomer are chosen.

By way of non-limiting example, aliphatic and/or cycloaliphatic diisocyanates having a molecular weight ranging from about 240 g/mol to about 285 g/mol, such as about 260 g/mol to about 265 g/mol, may be chosen. In certain embodiments, aliphatic or cycloaliphatic diisocyanates having an N═C═O content ranging from about 30% to about 35%, may be used. In certain embodiments, aliphatic or cycloaliphatic diisocyanates having a viscosity ranging from about 25 mPa-s to about 35 mPa·s, such as about 29 mPa·s to about 31 mPa-s, may be chosen. In certain embodiments, aliphatic or cycloaliphatic diisocyanates having from about 15% to about 25% of the trans-, trans-stereoisomer, from about 25% to about 35% of the cis-, cis-stereoisomer, and from about 45% to about 55% of the cis-, trans-stereoisomer may be used.

In a further non-limiting example, cycloaliphatic diisocyanates having a molecular weight of about 260 g/mol to about 265 g/mol, for example about 262 g/mol, an N═C═O content ranging from about 31% to about 32%, from about 18% to about 22% of the trans-, trans-stereoisomer, from about 28% to about 32% of the cis-, cis-stereoisomer, and from about 48% to about 52% of the cis-, trans-stereoisomer, and a viscosity of about 30 mPa·s are chosen.

In various embodiments, the crosslinking agent may include 4,4′-methylenedi(cyclohexyl isocyanate), hexamethylene-1,6-diisocyanate, homopolymers of hexamethylene diisocyanate, dicyclohexylmethane-2,4′-diisocyanate, dicyclohexyl-methane-2,2′-diisocyanate, or mixtures of any two or more thereof.

In certain preferred embodiments, the crosslinking agent 4,4′-methylenedi(cyclohexyl isocyanate) corresponding to formula (II) is used:

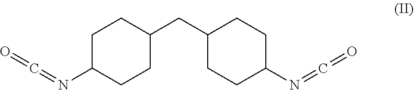 [SMILES: O=C=NC1CCC(CC2CCC(N=C=O)CC2)CC1]

In various embodiments, 4,4′-methylenedi(cyclohexyl isocyanate) having a molecular weight ranging from about 260 g/mol to about 265 g/mol, such as about 262 g/mol, is chosen. In various embodiments, 4,4′-methylenedi(cyclohexyl isocyanate) having an N═C═O content ranging from about 31% to about 32%, is used. In various embodiments, 4,4′-methylenedi(cyclohexyl isocyanate) having a viscosity ranging from about 29 mPa·s to about 31 mPa·s, such as about 30 mPa·s, is used. In various embodiments, 4,4′-methylenedi(cyclohexyl isocyanate) having from about 18% to about 22% of the trans-, trans-stereoisomer, from about 28% to about 32% of the cis-, cis-stereoisomer, and from about 48% to about 52% of the cis-, trans-stereoisomer is used.

In a particularly preferred embodiment, 4,4′-methylenedi(cyclohexyl isocyanate) having a molecular weight ranging from about 250 g/mol to about 275 g/mol, such as from about 260 g/mol to about 265 g/mol, for example about 262 g/mol, an N═C═O content ranging from about 30% to about 35%, such as from about 31% to about 32%, a viscosity ranging from about 25 mPa-s to about 35 mPa-s, such as about 30 mPa-s, and from about 15% to about 25%, such as from about 18% to about 22% of the trans-, trans-stereoisomer, from about 25% to about 35%, such as from about 28% to about 32% of the cis-, cis-stereoisomer, and from about 45% to about 55%, such as from about 48% to about 52% of the cis-, trans-stereoisomer, is chosen.

Combinations of two or more aliphatic and/or cycloaliphatic diisocyanates can also be used. In various embodiments, the aliphatic and/or cycloaliphatic diisocyanate comprises, consists essentially of, or consists of 4,4′-methylenedi(cyclohexyl isocyanate). In some embodiments, the aliphatic and/or cycloaliphatic diisocyanate comprises, consists essentially of, or consists of 4,4′-methylenedi(cyclohexyl isocyanate) having a molecular weight of about 260 g/mol to about 265 g/mol, for example about 262 g/mol, an N═C═O content ranging from about 30% to about 35%, from about 15% to about 25% of the trans-, trans-stereoisomer, from about 25% to about 35% of the cis-, cis-stereoisomer, and from about 45% to about 55% of the cis-, trans-stereoisomer, and a viscosity ranging from about 25 mPa·s to about 35 mPa·s. In some embodiments, the aliphatic and/or cycloaliphatic diisocyanate comprises, consists essentially of, or consists of 4,4′-methylenedi(cyclohexyl isocyanate) having a molecular weight of about 260 g/mol to about 265 g/mol, for example about 262 g/mol, an N═C═O content ranging from about 31% to about 32%, from about 18% to about 22% of the trans-, trans-stereoisomer, from about 28% to about 32% of the cis-, cis-stereoisomer, and from about 48% to about 52% of the cis-, trans-stereoisomer, and a viscosity of about 30 mPa·s.

In further embodiments the disclosure relates to a crosslinked polymer. In one exemplary and non-limiting embodiment, the polymer backbone may comprise, consist essentially of, or consist of poly(ethylene-co-vinyl acetate) (EVA) that is partially hydrolyzed. This hydrolysis may unblock or liberalize hydroxyl “functional” groups which may then undergo crosslinking with a crosslinking agent such as a diisocyanate monomer, e.g. 4,4′-methylenedi(cyclohexyl isocyanate), during the coating or macro encapsulation process at a surface of a substrate, for example a metal substrate. In some embodiments, therefore, the crosslinked polymer may be a urethane crosslinked vinyl acetate polymer. The degree of hydrolysis, e.g. EVA-acetate group hydrolysis, is a parameter that may be useful to control the properties of the polymer. For example, in at least one embodiment, the hydrolysis process may be controlled so as to remove a desired number of acetate-groups and replace them with hydroxyl-groups to achieve an optimal balance of moisture barrier and connection between molecules. As a non-limiting example, a degree of hydrolysis ranging from about 25% to about 75% may be chosen.

### Methods of Making the Compositions and Methods of Treating a Substrate

Without wishing to be bound by theory, it is believed that by choosing aliphatic and/or cycloaliphatic diisocyanates having the properties identified herein for crosslinking the partially hydrolyzed polymer, the compositions provide properties far superior to those achieved with other crosslinking agents and/or polymers, such as, for example, improved tensile strength, impact strength, split-tear strength, chemical/solvent resistance, flammability resistance, resilience, and/or weatherability. In particular, it is believed that the crosslinking agent having the properties identified herein has an optimal crosslinking rate when combined with the partially hydrolyzed polymer, in particular at the temperatures disclosed herein, which surprisingly aids the partially hydrolyzed polymer's bonding with the molecular level of the substrate to form an impermeable surface.

To prepare the compositions, the partially hydrolyzed polymer may be dissolved in a solvent, preferably a nonpolar solvent. The solvent may be, for example, xylene, toluene, benzene, chlorobenzene, carbon tetrachloride, methylchloride, cyclohexananol, butanol, butyl acetate, methoxypropyl acetate, or the like. Toluene is a particularly useful nonpolar solvent. The ratio of polymer to solvent may range from about 1:50 to about 5:1, such as from about 1:25 to about 1:1, from about 1:10 to about 1:1, or from about 1:5 to about 1:1. Optionally, the solution may be heated to a temperature of greater than about 55° C., such as greater than about 65° C., greater than about 75° C., greater than about 85° C., or greater than about 90° C., as appropriate for dissolving the polymer, optionally stirred, and optionally subsequently cooled to a temperature ranging from about 20° C. to about 30° C., before combining with the crosslinking agent.

Preferably, the crosslinking reaction occurs at a temperature ranging from about 20° C. to about 30° C., such as from about 22° C. to about 26° C., or from about 23° C. to about 25° C., preferably about 24° C. Typically, the period of time suitable to achieve complete or substantially complete crosslinking can range from a few minutes up to several days, e.g. from about 1 minute up to about 48 hours, from about 5 minutes to about 24 hours, from about 10 minutes to about 12 hours, or from about 15 minutes to about 2 hours.

Since properties of adhesion and strength inversely depend in part on the degree to which the polymer is crosslinked, the partially hydrolyzed polymer and crosslinking agent may be used in various ratios, depending on the degree of crosslinking of the polymer desired. In various embodiments, therefore, the degree of crosslinking may range from about 10% to about 80%, such as from about 20% to about 60%, from about 25% to about 55%, from about 30% to about 50%, from about 35% to about 45%, or from about 37% to about 43%, including all ranges and subranges thereof. In other embodiments, the degree of crosslinking may range from about 25% to about 75%. Thus, in some embodiments, the weight ratio of partially hydrolyzed polymer to crosslinking agent may range from about 6:1 to about 1:6, such as from about 5:1 to about 1:5, about 4:1 to about 1:4, about 3:1 to about 1:3, about 2:1 to about 1:2, about 1.5:1 to about 1:1.5, or about 1:1. In other embodiments, the weight ratio of partially hydrolyzed polymer to crosslinking agent may range from about 6:1 to about 1:1, such as from about 5:1 to about 1:1, about 4:1 to about 1:1, about 3:1 to about 1:1, or about 2:1 to about 1:1. For example, the weight ratio of partially hydrolyzed polymer to crosslinking agent may be about 6:1, about 5.5:1, about 5:1, about 4.5:1, about 4:1, about 3.5:1, about 3:1, about 2.5:1, about 2:1, about 1.5:1, or about 1:1, or may be chosen from any range using any two of the aforementioned as endpoints.

In addition, compositions according to the disclosure have advantageously been found to permit inclusion of additional components, without a reduction in beneficial properties, which is a significant advance over known anti-corrosion coating compositions. For example, the compositions can include colorants such as pigments, corrosion inhibitors, and/or other components that may be useful for application to the substrate.

The compositions may be applied to the substrate, such as a metal substrate, by any known method. Typically, compositions for preventing and/or reducing corrosion are applied to a substrate by methods such as dipping, brushing, rolling, spraying, and the like. For example, compositions according to the disclosure may be applied by spraying the compositions onto a substrate using conventional plural-component spray systems such as the Graco XM or XP lines of plural-component sprayers.

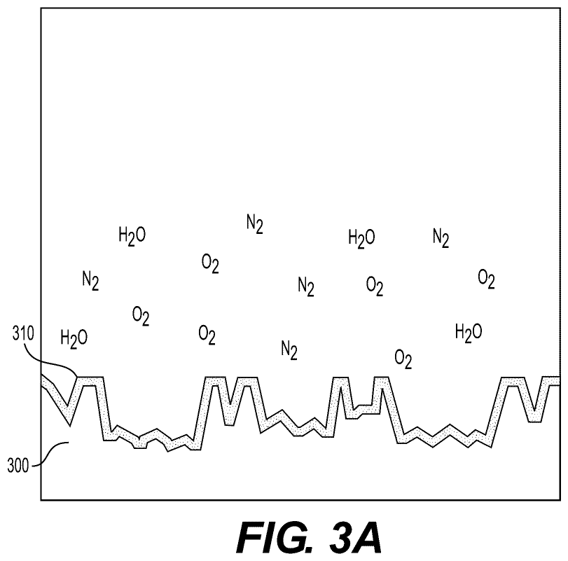

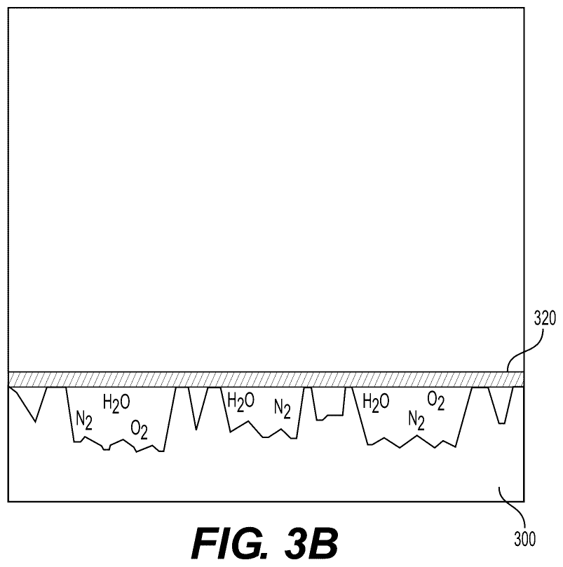

By way of non-limiting example, the following description may be useful for coating a metal substrate with a crosslinked polymer according to an embodiment of the disclosure. It is generally believed that adhesion of a coating to a metal substrate surface depends at least in part upon the disposition of environmental molecules adsorbed to the surface of the substrate, when the coating is applied thereto. These so-called “interfering molecules” may be dissolved and removed by a solvent such as toluene (which may also act as a continuous phase of the coating) used in the process, which may thereby allow the polymer to have direct access to the metal surface. Because of the lower free energy of the metal-solvent (e.g. metal-toluene) interface, the polymer (e.g. EVA) and nascent pre-polymers are believed to randomly aggregate upon the surface at the molecular level. Subsequent crosslinking yields a void-free, or substantially void-free, film on the metal substrate. This film may, therefore, be superior to traditional coatings, where interfering molecules that are trapped by the coating or even variations or defects on the surface of the metal substrate may result in voids or other defects in the film, as shown in FIGS. 3A-3B.

Although compositions according to the disclosure have the advantageous benefit of being able to provide impermeable, lasting coatings with application of only one composition, it may be desired to implement methods that include application of a system of multiple compositions, which may be the same or different, according to the disclosure. For example, a method may comprise application of clear or colored composition according to the disclosure as a sole corrosion resistant treatment, or may comprise application of a primer composition according to the disclosure, followed by application of a topcoat composition according to the disclosure, and/or a sealer composition according to the disclosure, as a system of corrosion resistant treatments which do not, or do not substantially, yellow over time and/or with exposure to UV radiation.

Although compositions described herein are useful for preventing and/or reducing corrosion when applied to metal substrates, it should be understood that other uses where improved impermeability, adhesion, and/or clarity are desired are also contemplated by the disclosure. For example, in one embodiment, methods of reducing or preventing yellowing of a substrate are disclosed, wherein the methods comprise treating the substrate with a composition or crosslinked polymer as described herein.

Without limitation, the methods of improving impermeability, improving adhesion, improving clarity, reducing or preventing corrosion, reducing or preventing yellowing, etc., may be achieved by compositions, films, polymers, and methods according to the disclosure, and such properties may last for a period of time of at least about 2 years, such as at least about 4 years, at least about 5 years, at least about 7 years, at least about 10 years, at least about 12 years, at least about 15 years, at least about 17 years, at least about 20 years, at least about 22 years, or at least about 25 years, such as, for example, from about 2 to about 35 years, from about 5 to about 35 years, from about 7 to about 35 years, from about 10 to about 35 years, from about 12 to about 35 years, from about 15 to about 35 years, from about 17 to about 35 years, from about 2 to about 30 years, from about 5 to about 30 years, from about 7 to about 30 years, from about 10 to about 30 years, from about 12 to about 30 years, from about 15 to about 30 years, from about 17 to about 30 years, from about 2 to about 25 years, from about 5 to about 25 years, from about 7 to about 25 years, from about 10 to about 25 years, from about 12 to about 25 years, from about 15 to about 25 years, from about 17 to about 25 years, from about 20 to about 25 years, from about 2 to about 20 years, from about 5 to about 20 years, from about 7 to about 20 years, from about 10 to about 20 years, from about 12 to about 20 years, from about 15 to about 20 years, or from about 17 to about 20 years.

Having described the many embodiments of the present invention in detail, it will be apparent that modifications and variations are possible without departing from the scope of the disclosure defined in the appended claims. Furthermore, it should be appreciated that all examples in the present disclosure, while illustrating many embodiments of the disclosure, are provided as non-limiting examples and are, therefore, not to be taken as limiting the various aspects so illustrated. It is to be understood that all definitions herein are provided for the present disclosure only.

As used herein, the terms “comprising,” “having,” and “including” (or “comprise,” “have,” and “include”) are used in their open, non-limiting sense. The phrase “consisting essentially of” limits the scope of a claim to the specified materials or steps and those that do not materially affect the basic and novel characteristics of the compositions.

In this application, the use of the singular includes the plural unless specifically stated otherwise. The singular forms “a,” “an,” “the,” “at least one,” “one or more,” and the like are understood to encompass the plural as well as the singular unless the context clearly dictates otherwise, and these expressions are expressly intended to include the individual components as well as mixtures/combinations thereof. Thus, where the disclosure refers to “an element selected from the group consisting of A, B, C, D, E, F, or mixtures thereof,” it indicates that that only one or more of A, B, C, D, or F may be included, a mixture of any two of A, B, C, D, E, or F may be included, etc.

The term “and/or” should be understood to include both the conjunctive and the disjunctive. For example, “A and/or B” means “A and B” as well as “A or B,” and expressly covers instances of either without reference to the other. For example, “preventing and/or reducing” corrosion includes instances of preventing corrosion and reducing corrosion, as well as instances where corrosion is reduced but not prevented, etc.

As used herein, the phrases “and mixtures thereof,” “and a mixture thereof,” “and combinations thereof,” “and a combination thereof,” “or mixtures thereof,” “or a mixture thereof,” “or combinations thereof,” and “or a combination thereof,” and the like are used interchangeably to denote that the listing of components immediately preceding the phrase, such as “A, B, C, D, or mixtures thereof” signifies that the component(s) may be chosen from A, from B, from C, from D, from A+B, from A+B+C, from A+D, from A+C+D, etc., without limitation on the variations thereof. Thus, the components may be used individually or in any combination thereof.

As used herein, “free” means that the component or property is not detectable using accepted methodologies, and “substantially” or “essentially” free means that the component or property, while detectable using accepted methodologies, is negligible. For example, a film or coating that is “free” of voids has no detectable voids, whereas a film or coating that is “substantially free” of voids may have detectable voids, but such voids would be considered negligible by a person skilled in the art.

As used herein, “prevent,” “preventing,” and the like means that the condition does not occur over an identified period of time. For example, a method of “preventing” corrosion for a period of at least five years by coating a substrate according to the disclosure means that a person skilled in the art, using accepted methodologies for evaluating corrosion, would conclude that the coated substrate did not corrode over a period of five years or more.

As used herein, “reduce,” “reducing,” and the like means that the condition occurs over an identified period of time at a lesser rate. For example, a method of “reducing” corrosion for a period of at least five years by coating a substrate according to the disclosure means that a person skilled in the art, using accepted methodologies for evaluating corrosion, would detect less corrosion of the coated substrate than that seen on a substantially identical substrate exposed to substantially identical conditions but which is either not coated or is coated but with a composition not according to the disclosure, for a period of five years or more.

In the present disclosure, “corrosion” is used according to its ordinary meaning, and is generally understood by those of skill in the art to refer to degradation of a substrate over a period of time, typically by chemical or electrochemical reaction with the environment in which the substrate is present.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value. All ranges and amounts given herein are intended to include sub-ranges and amounts using any disclosed point as an end point. Thus, a range of “1% to 10%, such as 2% to 8%, such as 3% to 5%,” is intended to encompass ranges of “1% to 8%,” “1% to 5%,” “2% to 10%,” and so on. All numbers, amounts, ranges, etc., are intended to be modified by the term “about,” whether or not so expressly stated. Similarly, a range given of “about 1% to 10%” is intended to have the term “about” modifying both the 1% and the 10% endpoints. The term “about” is used herein to indicate a difference of up to +/−10% from the stated number, such as +/−9%, +/−8%, +/−7%, +/−6%, +/−5%, +/−4%, +/−3%, +/−2%, or +/−1%. Likewise, all endpoints of ranges are understood to be individually disclosed, such that, for example, a range of 1:2 to 2:1 is understood to disclose a ratio of both 1:2 and 2:1. All ranges are understood to expressly include the endpoints of such ranges.

As described herein, all viscosity measurements are to be understood as being measured at about 23° C., following DIN EN ISO 3219/A.3 protocol.

Unless otherwise expressly stated, it is in no way intended that any method set forth herein be construed as requiring that its steps be performed in a specific order. Accordingly, where a method does not expressly recite an order to be followed by its steps or it is not specifically stated that the steps are to be limited to a specific order, it is no way intended that any particular order be inferred.

### EXAMPLES

The following examples are intended to be non-limiting and explanatory in nature only.

### Example 1A—Clear Composition Useful for Reducing and/or Preventing Corrosion

A composition was prepared by heating 300 mL toluene to about 86° C. and dissolving 30 grams of a partially hydrolyzed poly(ethylene vinyl acetate) polymer (degree of hydrolysis ranging from about 38% to about 55%, ethylene content of about 70%, vinyl alcohol content ranging from about 12% to about 13%, vinyl acetate content ranging from about 17% to about 18%) in toluene at a weight ratio of polymer:toluene of about 1:10 by stirring at a temperature of about 86° C. for about 15 minutes. The solution was cooled to a temperature of about 24° C., and 7.5 grams of 4,4′-methylenedi(cyclohexyl isocyanate) having a molecular weight of about 262 g/mol, a viscosity of about 30 mPa-s, an N═C═O content of about 31% to about 32%, and having from about 18% to about 22% of the trans-, trans-stereoisomer, from about 28% to about 32% of the cis-, cis-stereoisomer, and from about 48% to about 52% of the cis-, trans-stereoisomer, was added to give a weight ratio of polymer:crosslinker of about 4:1. After about 15 minutes, a highly crosslinked polymer having a degree of crosslinking of about 25% was obtained.

### Example 1B—Colored Compositions Useful for Reducing and/or Preventing Corrosion

The procedure of Example 1A was repeated, but about 63 grams of one of three different pigments, royal blue, international orange, or corten brown, was added with stirring. Separately, the procedure of Example 1A was repeated but 16.5 grams of olive drab green was added with stirring to produce a composition having a green tint.

### Example 1C—Zinc-Containing Primer Composition Useful for Reducing and/or Preventing Corrosion

The procedure of Example 1A was repeated, but about 1,879 grams of zinc was added with stirring. The resulting zinc-rich composition had a concentration of zinc of about 82%.

### Example 2A—Evaluation of Film Permeability

Films were prepared using compositions prepared according to the procedure of Example 1A (clear) or 1B (including a colorant), with varying ratios of polymer:crosslinker for polymers having varying degrees of crosslinking. Permeability testing of the films was performed using ASTM E96-05 procedures as follows.

Test conditions were 23° C. and 50% relative humidity. Each film had an exposed area of approximately 3″×3″ and the test cups were sealed with wax and contained approximately 80 grams of desiccant. Each film was tested in triplicate. Table 1A provides average results for each film.

TABLE 1A

| | | Average | | |
|---|---|---|---|---|
| | Average | Degree of | Average | Average |
| | Thickness | Crosslinking | Transmission | Permeance |
| Film | (mils) | (%) | (g/[h × m²]) | (g/[Pa · s × m²]) |
| 1 | 2.7¹ | 25 | 0.58 | 1.14 × 10⁻⁷ |
| 2 | 1.4² | 50 | 0.58 | 1.15 × 10⁻⁷ |

¹3.3 mils, 3.1 mils, 4.0 mils;
²1.0 mils, 1.6 mils, 1.0 mils

As can be seen in Table 1A, films produced with compositions according to the disclosure have surprisingly significant water vapor impermeability.

### Example 2B—Evaluation of Film Permeability

The procedure of Example 2A was repeated, except that each film had an exposed area of approximately 7.1″×7.1″ and approximately 100 grams of desiccant was used. Each film was again tested in triplicate. Table 1B provides average results for each film.

TABLE 1B

| | | Average | | |
|---|---|---|---|---|
| | Average | Degree of | Average | Average |
| | Thickness | Crosslinking | Transmission | Permeance |
| Film | (mils) | (%) | (g/[h × m²]) | (g/[Pa · s × m²]) |
| 3 | 2.7¹ | 25 | 0.58 | 1.14 × 10⁻⁷ |
| 4 | 2.3³ | 25 | 0.62 | 1.23 × 10⁻⁷ |
| 5 | 1.4² | 50 | 0.58 | 1.14 × 10⁻⁷ |
| 6 | 1.3⁴ | 50 | 0.61 | 1.20 × 10⁻⁷ |

¹3.3 mils, 3.1 mils, 4.0 mils;
²1.0 mils, 1.6 mils, 1.0 mils;
³2.0 mils, 2.6 mils, 3.0 mils;
⁴1.75 mils, 1.4 mils, 1.3 mils

The results in Table 1B confirm the surprising water vapor impermeability results of films prepared with compositions according to the disclosure.

### Example 2C—Evaluation of Film Permeability

The procedure of Example 2A was repeated, except that no colorant was included, and each film had an exposed area of approximately 7.1″×7.1″ and a degree of crosslinking of about 25%. Each film was again tested in triplicate. Table 1C provides results of the average for each film.

TABLE 1C

| | Average | Average | Average |
|---|---|---|---|
| | Thickness | Transmission | Permeance |
| Film | (mils) | (g/[h × m²]) | (g/[Pa · s × m²]) |
| 7 | 1.9⁵ | 0.54 | 1.06 × 10⁻⁷ |
| 8 | 7.4⁶ | 0.19 | 3.68 × 10⁻⁸ |
| 9 | 1.5⁷ | 0.81 | 1.61 × 10⁻⁷ |
| 10 | 1.4⁸ | 0.61 | 1.21 × 10⁻⁷ |
| 11 | 1.8⁹ | 0.53 | 1.04 × 10⁻⁷ |
| 12 | 1.6¹⁰ | 0.85 | 1.69 × 10⁻⁷ |
| 13 | 1.8¹¹ | 0.56 | 1.12 × 10⁻⁷ |
| 14 | 1.8¹² | 0.73 | 1.45 × 10⁻⁷ |

⁵1.7 mils, 2.0 mils, 2.1 mils;
⁶7.3 mils, 7.5 mils, 6.3 mils;
⁷1.1 mils, 1.5 mils, 1.5 mils;
⁸1.3 mils, 1.4 mils, 1.4 mils;
⁹1.7 mils, 1.9 mils, 1.8 mils;
¹⁰1.8 mils, 1.8 mils, 1.5 mils;
¹¹2.0 mils, 1.9 mils, 1.9 mils;
¹²1.7 mils, 1.7 mils, 1.6 mils

The results in Table 1C further confirm the surprising water vapor impermeability results of films prepared with compositions according to the disclosure.

Examples 2A-2C thus demonstrate the surprising and unexpected superior impermeability of films prepared from compositions according to the disclosure.

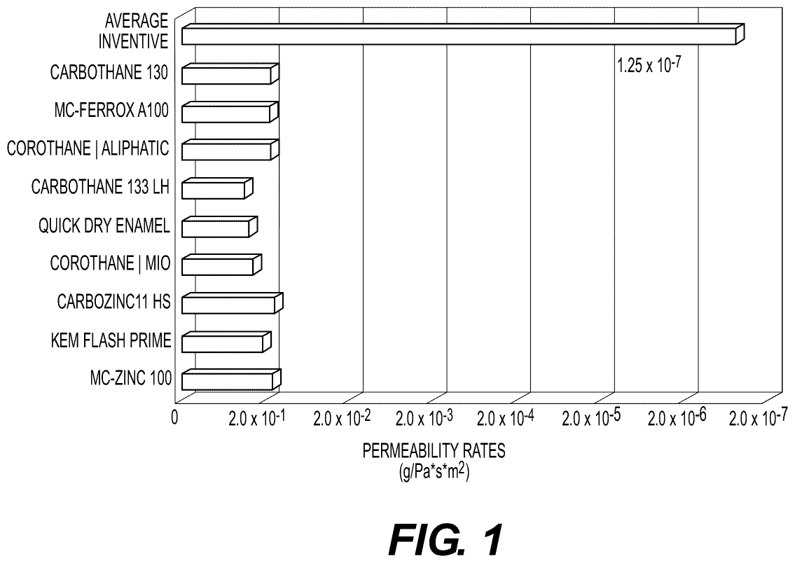

Based on the test results reported in Tables 1A-1C and additional testing of compositions according to the disclosure, it was found that, regardless of thickness, on average films prepared according to the disclosure show a water vapor permeability of about 1.25×10⁻⁷ grains/Pa·s×m², which is a significant improvement over commercial anti-corrosion coatings. FIG. 1 is a graph comparing the average impermeability level imparted by compositions according to the disclosure with that reported for various commercial anti-corrosion coatings.

### Example 3—Coated Substrates

A composition prepared according to the procedure of Example 1A having a degree of crosslinking of about 25% was applied to various substrates using a Meyer Rod coating system. The substrates were then subjected to various testing.

Adhesion testing was performed using ASTM D4541-09 Pull-Off Strength procedures to evaluate the adhesion strength of the composition on the surface of the substrates. Corrosion resistance was evaluated for the steel substrates using the ASTM D5894-10 Cyclic Salt/Fog/UV procedures (3 cycles, 1008 hours). Average results for these tests are summarized in Table 2.

TABLE 2

| | Adhesion | | Corrosion Resistance | |
|---|---|---|---|---|
| Substrate | Thickness | psi | Thickness | Rating |
| A36 carbon | 125 mils | 1860-2586 | 125 mils | No rusting/Rating 10; |
| steel | | | | No blistering |
| 1010 cold | 109 mils | 1786-2418 | 32 mils | No rusting/Rating 10; |
| rolled steel | | | | No blistering |

| | | | |
|---|---|---|---|
| Fiberglass | 425 mils | 2231* | — |
| reinforced | | | |
| polyester | | | |
| panel | | | |
| Glass | 156 mils | 1562 | — |

*failure of the panel

The data in Table 2 demonstrate that the adhesion strength of compositions according to the disclosure on the substrates is superior, particularly on metal substrates.

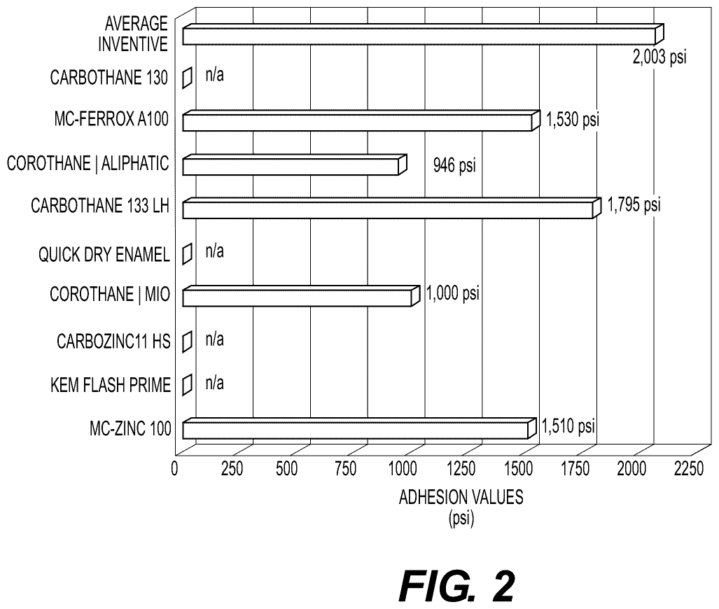

Based on the test results reported in Table 2 and testing of twenty additional films according to the disclosure having thicknesses ranging from 6 mils to 8 mils on 1010 cold rolled steel in the same manner, it was found that films according to the disclosure have an average adhesion strength of about 2003 psi, which is a significant improvement over commercial anti-corrosion coatings. FIG. 2 is a graph comparing the adhesion values of various industrial anticorrosive protective urethane-coatings available in the U.S., as published by the underlying manufacturers, to this average adhesion strength of compositions according to the disclosure as measured by independent third-party testing labs.

Without wishing to be bound by theory, it is believed that this superior adhesion is due to interaction of the partially hydrolyzed polymer at the surface of the substrate, which is then crosslinked onto the substrate during the process. This is seen in FIG. 3A which shows a substrate 300 that has a composition according to the disclosure 310 applied thereto, compared to the same substrate 300 which has a traditional anti-corrosion coating 320 applied as seen in FIB. 3B.

Additionally, the data in Table 2 demonstrate that compositions according to the disclosure provide superior corrosion resistance to the steel substrates, with both substrates demonstrating no rusting (Rating 10) when evaluated per ASTM D610, and no blistering when evaluated per ASTM D714.

Example 3 thus demonstrates the surprising and unexpected superior adhesion and anti-corrosion properties imparted to substrates by compositions and methods according to the disclosure.

### Example 4—Accelerated Weathering Testing

Two films were prepared using compositions prepared according to the procedure of Example 1A, with thicknesses of 4 mils and 8 mils. Ten comparative films having thicknesses ranging from 4 mils to 10 mils were prepared according to the procedure in Example 1A with varying ratios of polymer:crosslinker in order to prepare polymers having degrees of crosslinking of either 25% or 50%, but the crosslinker was an aromatic polyisocyanate based on toluene diisocyanate.

Accelerated weathering testing of the films was performed using ASTM G 155-05a procedures as follows, for 1000 hours. The cycle consisted of 1:42 of irradiance (xenon arc burner fitted with quartz inner filter and “Type S” borosilicate outer filter) set to 0.35 W/m² at 340 nm, black panel set to 63° C., chamber air temperature 42° C., 50% relative humidity, followed by 0:18 of irradiance with water spray. The samples were evaluated for haze and luminance transmittance prior to the testing (To), and then every 250 hours per ASTM D 1003-07 (T₂₅₀, T₅₀₀, T₇₅₀, T₁₀₀₀). The results are shown in Tables 3A-3B.

TABLE 3A
Inventive Films

| | | | Yellowness | Transmittance |
|---|---|---|---|---|
| | | Transmittance | Index | Haze % |
| Film | Time | (%) | (D65/10°) | (D65/10°) |
| 15 | T₀ | 90.95 | 0.99 | 0.8 |
| | T₂₅₀ | 90.34 | 1.00 | 1.0 |
| | T₅₀₀ | 90.52 | 1.18 | 1.1 |
| | T₇₅₀ | 90.72 | 0.94 | 1.1 |
| | T₁₀₀₀ | 90.80 | 1.02 | 1.2 |
| 16 | T₀ | 90.93 | 0.65 | 1.2 |
| | T₂₅₀ | 90.36 | 0.73 | 1.5 |
| | T₅₀₀ | 91.00 | 0.45 | 1.1 |
| | T₇₅₀ | 91.16 | 0.49 | 1.1 |
| | T₁₀₀₀ | 91.34 | 0.59 | 1.1 |

TABLE 3B
Comparative Films

| | | | Yellowness | Transmittance |
|---|---|---|---|---|
| | | Transmittance | Index | Haze % |
| Film | Time | (%) | (D65/10°) | (D65/10°) |
| C1 | T₀ | 90.57 | 0.86 | 15.5 |
| | T₂₅₀ | 85.28 | 11.21 | 2.50 |
| | T₅₀₀ | 84.95 | 15.86 | 2.20 |
| | T₇₅₀ | 85.25 | 16.64 | 2.30 |
| | T₁₀₀₀ | 85.98 | 14.09 | 2.60 |
| C2 | T₀ | 90.03 | 0.93 | 16.3 |
| | T₂₅₀ | 86.19 | 10.28 | 2.00 |
| | T₅₀₀ | 85.55 | 14.83 | 2.00 |
| | T₇₅₀ | 86.50 | 13.41 | 2.10 |
| | T₁₀₀₀ | 87.35 | 10.78 | 2.20 |
| C3 | T₀ | 90.63 | 0.84 | 14.50 |
| | T₂₅₀ | 81.66 | 19.92 | 1.90 |
| | T₅₀₀ | 79.93 | 28.49 | 2.10 |
| | T₇₅₀ | 80.37 | 29.93 | 2.30 |
| | T₁₀₀₀ | 8,0.84 | 29.04 | 2.50 |
| C4 | T₀ | 90.50 | 0.94 | 14.60 |
| | T₂₅₀ | 81.89 | 19.58 | 1.60 |
| | T₅₀₀ | 79.71 | 28.96 | 2.00 |
| | T₇₅₀ | 79.94 | 30.75 | 2.10 |
| | T₁₀₀₀ | 80.42 | 30.09 | 2.30 |
| C5 | T₀ | 91.39 | 0.50 | 14.20 |
| | T₂₅₀ | 85.48 | 11.49 | 1.70 |
| | T₅₀₀ | 84.52 | 16.93 | 1.80 |
| | T₇₅₀ | 84.62 | 17.67 | 2.10 |
| | T₁₀₀₀ | 84.82 | 16.25 | 2.30 |
| C6 | T₀ | 91.63 | 0.44 | 14.40 |
| | T₂₅₀ | 85.18 | 11.72 | 2.00 |
| | T₅₀₀ | 84.64 | 15.48 | 2.10 |
| | T₇₅₀ | 85.11 | 16.33 | 2.10 |
| | T₁₀₀₀ | 85.46 | 15.48 | 2.20 |
| C7 | T₀ | 91.35 | 0.43 | 14.10 |
| | T₂₅₀ | 81.63 | 18.67 | 1.80 |
| | T₅₀₀ | 80.04 | 26.91 | 2.30 |
| | T₇₅₀ | 80.62 | 27.78 | 2.40 |
| | T₁₀₀₀ | 81.19 | 27.14 | 2.60 |
| C8 | T₀ | 91.31 | 0.44 | 14.50 |
| | T₂₅₀ | 81.75 | 18.75 | 1.90 |
| | T₅₀₀ | 80.16 | 26.91 | 2.50 |
| | T₇₅₀ | 80.67 | 28.34 | 2.40 |
| | T₁₀₀₀ | 81.65 | 27.59 | 2.60 |
| C9 | T₀ | 89.83 | 2.01 | 14.40 |
| | T₂₅₀ | 83.91 | 13.46 | 3.00 |
| | T₅₀₀ | 83.51 | 20.73 | 2.20 |
| | T₇₅₀ | 85.28 | 17.33 | 2.20 |
| | T₁₀₀₀ | 86.71 | 11.76 | 2.70 |
| C10 | T₀ | 89.93 | 1.90 | 14.60 |
| | T₂₅₀ | 83.42 | 18.42 | 2.30 |
| | T₅₀₀ | 83.98 | 19.28 | 2.30 |
| | T₇₅₀ | 85.82 | 14.65 | 2.30 |
| | T₁₀₀₀ | 87.35 | 9.79 | 2.80 |

As can be seen in Table 3A, inventive films 15 and 16 maintained their clarity and did not yellow, and showed almost no variation in transmittance or haze over the course of the study. These results can be extrapolated to conclude that films prepared from compositions according to the disclosure are surprisingly expected to maintain clarity over a period of normal UV and weather exposure of at least 10, and more likely at least 20, years. In contrast, as seen in Table 3B, comparative films C1-C10 demonstrated significant yellowing as well as significant decrease in transmittance and haze over the course of the study.

Example 4 thus demonstrates that the compositions according to the disclosure provide superior results with respect to appearance over an extended period of time under expected conditions of use compared to compositions not according to the disclosure, i.e. compositions using crosslinkers other than those disclosed herein.

The above examples demonstrate that compositions according to the present disclosure have surprisingly and expectedly superior benefits compared to prior anti-corrosion compositions, including significantly improved film clarity (minimal or no UV susceptibility), impermeability, and adhesion. In addition, the compositions according to the disclosure are able to incorporate pigments or colorants, or other components such as zinc, without losing such beneficial properties, which is also surprising and unexpected compared to known compositions.

It will be apparent to those skilled in the art that various modifications and variations can be made in the compositions and methods according to the disclosure without departing from the spirit or scope of the disclosure. Thus, it is intended that the disclosure cover such modifications and variations and their equivalents.

1-31. (canceled)

32. A method for preventing yellowing of a substrate, the method comprising applying to the substrate a composition prepared by crosslinking:
(a) at least one cross-linkable, partially hydrolyzed polymer of formula (I):
—(CH₂CHOH)ₓ—(CH₂CH₂)_{y}—(CH₂CHOCOCH₃)_{z}— (I)
wherein x, y, and z independently represent mol fractions of ethylene, vinyl alcohol, and vinyl acetate, respectively; and
(b) at least one crosslinking agent at least one crosslinking agent chosen from 4,4′-methylenedi(cyclohexyl isocyanate) and homopolymers of hexamethylene diisocyanate,
wherein the cross-linkable, partially hydrolyzed polymer has a molecular weight ranging from about 180,000 to about 220,000 and a degree of hydrolysis ranging from about 30% to about 60%, and
wherein the crosslinking reaction occurs at a temperature ranging from about 20° C. to about 30° C.

33. The method according to claim 32, wherein the polymer of formula (I) comprises poly(ethylene vinyl acetate) having an ethylene content ranging from about 60% to about 80%, a vinyl alcohol content ranging from about 7% to about 18%, and a vinyl acetate content ranging from about 10% to about 25%.

34. The method according to claim 32, wherein the composition further comprises one or more crosslinking agents chosen from hexamethylene-1,6-diisocyanate, dicyclohexylmethane-2,4′-diisocyanate, dicyclohexyl-methane-2,2′-diisocyanate, or combinations of two or more thereof.

35. The method according to claim 32, wherein the weight ratio of cross-linkable, partially hydrolyzed polymer to crosslinking agent in the composition ranges from about 6:1 to about 1:6.

36. The method according to claim 35, wherein the polymer of formula (I) comprises poly(ethylene vinyl acetate) polymer having an ethylene content of about 70%, a vinyl alcohol content ranging from about 12% to about 13%, and a vinyl acetate content ranging from about 17% to about 18%.

37. The method according to claim 32, wherein the composition comprises:
(a) poly(ethylene vinyl acetate) having an ethylene content ranging from about 60% to about 80%, a vinyl alcohol content ranging from about 7% to about 18%, and a vinyl acetate content ranging from about 10% to about 25%; and
(b) at least one crosslinking agent comprising homopolymers of hexamethylene diisocyanate,
wherein the weight ratio of (a):(b) ranges from about 6:1 to about 1:6.

38. The method according to claim 37, wherein the poly(ethylene vinyl acetate) polymer has a degree of hydrolysis ranging from about 30% to about 60%.

39. The method according to claim 37, wherein the at least one crosslinking agent comprising homopolymers of hexamethylene diisocyanate and has an N═C═O content ranging from about 20% to about 25%.

40. The method according to claim 38, wherein the at least one crosslinking agent comprising homopolymers of hexamethylene diisocyanate and has an N═C═O content ranging from about 20% to about 25%.

41. The method according to claim 37, wherein the poly(ethylene vinyl acetate) polymer has a degree of crosslinking ranging from about 10% to about 55%.

42. The method according to claim 37, wherein the poly(ethylene vinyl acetate) polymer has an ethylene content of about 70%, vinyl alcohol content ranging from about 12% to about 13%, and vinyl acetate content ranging from about 17% to about 18%.

43. The method according to claim 40, wherein the poly(ethylene vinyl acetate) polymer has a degree of crosslinking ranging from about 10% to about 55%.

44. The method according to claim 40, wherein the poly(ethylene vinyl acetate) polymer has an ethylene content of about 70%, vinyl alcohol content ranging from about 12% to about 13%, and vinyl acetate content ranging from about 17% to about 18%.

45. A method for treating a substrate by molecularly bonding a partially hydrolyzed polymer to the substrate, the method comprising applying to the substrate a composition prepared by crosslinking:
(a) at least one cross-linkable, partially hydrolyzed polymer of formula (I):
—(CH₂CHOH)ₓ—(CH₂CH₂)_{y}—(CH₂CHOCOCH₃)_{z}— (I)
wherein x, y, and z independently represent mol fractions of ethylene, vinyl alcohol, and vinyl acetate, respectively; and
(b) at least one crosslinking agent at least one crosslinking agent chosen from 4,4′-methylenedi(cyclohexyl isocyanate) and homopolymers of hexamethylene diisocyanate,
wherein the cross-linkable, partially hydrolyzed polymer has a molecular weight ranging from about 180,000 to about 220,000 and a degree of hydrolysis ranging from about 30% to about 60%, and
wherein the crosslinking reaction occurs at a temperature ranging from about 20° C. to about 30° C.

46. The method according to claim 45, wherein the polymer of formula (I) comprises poly(ethylene vinyl acetate) having an ethylene content ranging from about 60% to about 80%, a vinyl alcohol content ranging from about 7% to about 18%, and a vinyl acetate content ranging from about 10% to about 25%.

47. The method according to claim 45, wherein the composition further comprises one or more crosslinking agents chosen from hexamethylene-1,6-diisocyanate, dicyclohexylmethane-2,4′-diisocyanate, dicyclohexyl-methane-2,2′-diisocyanate, or combinations of two or more thereof.

48. The method according to claim 45, wherein the weight ratio of cross-linkable, partially hydrolyzed polymer to crosslinking agent in the composition ranges from about 6:1 to about 1:6.

49. The method according to claim 48, wherein the polymer of formula (I) comprises poly(ethylene vinyl acetate) polymer having an ethylene content of about 70%, a vinyl alcohol content ranging from about 12% to about 13%, and a vinyl acetate content ranging from about 17% to about 18%.

50. The method according to claim 45, wherein the composition comprises:
(a) poly(ethylene vinyl acetate) having an ethylene content ranging from about 60% to about 80%, a vinyl alcohol content ranging from about 7% to about 18%, and a vinyl acetate content ranging from about 10% to about 25%; and
(b) at least one crosslinking agent comprising homopolymers of hexamethylene diisocyanate,
wherein the weight ratio of (a):(b) ranges from about 6:1 to about 1:6.

51. The method according to claim 50, wherein the poly(ethylene vinyl acetate) polymer has a degree of hydrolysis ranging from about 30% to about 60%, and the at least one crosslinking agent comprising homopolymers of hexamethylene diisocyanate and has an N═C═O content ranging from about 20% to about 25%.
